(19) United States
(12) Patent Application Publication
(10) Pub. No.: US 2009/0194540 A1
(43) Pub. Date: Aug. 6, 2009

(54) BAG SUPPORT FOR RECYCLING CENTER

(76) Inventors: Casey M. Dembowiak, Greenfield, WI (US); Edmund A. Malczewski, Milwaukee, WI (US); Mark D. Arnold, Dixon, IL (US)

Correspondence Address: BOYLE FREDRICKSON S.C., 840 North Plankinton Avenue, MILWAUKEE, WI, 53203, US

(21) Appl. No.: 12/025,313

(22) Filed: Feb. 4, 2008

(51) Int. Cl. B65D 25/16; B65D 6/18; B62B 3/00

(52) U.S. Cl. 220/495.06; 220/6; 280/639

(57) ABSTRACT

A bag frame assembly is provided for supporting a pliable bag. The bag has an upper edge defining an opening. The bag frame assembly includes a first frame member defined by first and second spaced rods having upper and lower ends. The upper ends of the rods are interconnected by a first upper cross frame member. A second frame member is pivotably connected to the first frame member and is defined by first and second spaced rods having upper and lower ends. The upper ends of the rods are interconnected by a second upper cross frame member. A first bag support extends downwardly from the first cross frame member. The first bag support and the first cross frame member define a closed, oblong loop. Similarly, a second bag support extends downwardly from the second cross frame member. The second bag support and the second cross frame member define a closed, oblong loop.

### FIELD OF THE INVENTION

This invention relates generally to recycling centers, and in particular, to a bag support receivable within the interior of a modular recycling center for supporting a conventional plastic bag in an open position.

### BACKGROUND AND SUMMARY OF THE INVENTION

As is known, the United States produces over 250 million tons of municipal solid waste each year. This number represents approximately 4.6 pounds of waste per person per day. A large portion of this waste is hauled away in garbage trucks and packed into sanitary landfills. As a result, landfilling has become the number disposing trash in the United States. However, most of the material disposed of in landfills is recyclable. Hence, in order to reduce the volume of waste disposed of in landfills, Americans have turned to recycling. It has be found that recycling benefits the environment at every stage in the life cycle of a consumer product, from the raw material used to make the product, to the final method of disposal. In order to encourage recycling, many public facilities have start to position recycling bins throughout their premises.

Typically, a recycling bin is defined by a housing having a plurality of openings or slots that provide access to the interior of the housing. A pliable bag is positioned within the interior of the housing to receive any recyclable material deposited in the openings or slots thereof. It can be appreciated that various types of bag holders have been developed to maintain the openings in the pliable bags in desired positions within the housings. By way of example, Mutert, U.S. Pat. No. 7,032,868 discloses a bag stand for supporting a bag during filling of the bag. More specifically, the bag stand includes first and second legs pivotable with respect to one another about a pivot axis. The first and second legs pivot between a first position wherein the first and second legs are substantially aligned with respected to each other for storage and a second position wherein the first and second legs are transverse with respect to each other in order to receive a bag. The upper portions of the first and second legs of the bag stand include excurvate portions adapted for receiving the upper edge of a bag and for a bag support receivable within the interior of a modular recycling center for supporting a conventional plastic bag in an open position.

While functional for their intended purpose, these prior bag supports have certain shortcomings. By way of example, the bag support disclosed in the '868 patent requires the upper edge of the bag to be weaved through various bends in the first and second legs in order to maintain the bag in position. It can be appreciated that it is often difficult for a user to properly interconnect the upper edge of the bag to the excurvate portions of the first and second legs. Hence, it is highly possible for the pliable bag to be disengaged from the bag stand during filling. If the pliable bag becomes disengaged from the bag stand, any recyclable material deposited in the openings or slots in the housing of the recycle bin may fall outside of the bag, thereby causing a mess within housing.

Therefore, it is a primary object and feature of the present invention to provide a bag support receivable within the interior of a modular recycling center for supporting a conventional plastic bag in an open position during the filling of the bag.

It is a further object and feature of the present invention to provide a bag support receivable within the interior of a modular recycling center for supporting a conventional plastic bag in an open position that is simple to utilize and inexpensive to manufacture.

It is a still further object and feature of the present invention to provide a bag support that may be easily inserted into the interior of a modular recycling center.

In accordance with the present invention, a bag frame assembly is provided for supporting a pliable bag. The bag has an upper edge defining an opening. The bag frame assembly includes a first frame member defined by first and second spaced rods having upper and lower ends. The upper ends of the rods are interconnected by a first upper cross frame member. A second frame member is pivotably connected to the first frame member and is defined by first and second spaced rods having upper and lower ends. The upper ends of the rods are interconnected by a second upper cross frame member. A first bag support extends downwardly from the first cross frame member. The first bag support and the first cross frame member define a closed, oblong loop. Similarly, a second bag support extends downwardly from the second cross frame member. The second bag support and the second cross frame member define a closed, oblong loop.

The first bag support is defined by a cross bar having first and second opposite ends. The cross bar is generally parallel to the first cross frame member. A first u-shaped connector has first and second parallel legs. The first leg is connected to the first upper cross frame member and the second leg is connected to and coaxial with the first end of the cross bar. A second u-shaped connector also has first and second parallel legs. The first leg is connected to the first upper cross frame member and the second leg is connected to and coaxial with the second end of the cross bar.

The second bag support is defined by a cross bar having first and second opposite ends. The cross bar is generally parallel to the second upper cross frame member. A first u-shaped connector has first and second parallel legs. The first leg is connected to the second upper cross frame member and the second leg is connected to and coaxial with the first end of the cross bar of the second bag support. A second u-shaped connector also has first and second parallel legs. The first leg is connected to the second upper cross frame member and the second leg is connected to and coaxial with the second end of the cross bar of the second bag support.

A first hinge is rigidly connected to the first rod of the first frame member and pivotably connected to the first rod of the second frame member. The first frame member and second frame member are pivotable between a first folded position and a second unfolded position. A second hinge is rigidly connected to the second rod of the first frame member and pivotably connected to the second rod of the second frame member. A stop extends from the first hinge. The stop is engageable with the first rod of the second frame member with the first frame member and second frame member in the unfolded position.

The first frame member is further defined by a first lower cross frame member interconnecting the lower ends of first and second spaced rods of the first frame member. The second frame member is further defined by a second lower cross frame member interconnecting the lower ends of first and second spaced rods of the second frame member. Roller wheels are rotatably connected to the first and second lower cross frame members.

In accordance with a further aspect of the present invention, a bag frame assembly is provided for supporting a pliable bag. The bag has an upper edge defining an opening. The bag frame assembly includes a first frame member defined by first and second spaced rods having upper and lower ends. The upper ends of the rods are interconnected by a first upper cross frame member. A second frame member is defined by first and second spaced rods having upper and lower ends. The upper ends of the rods are interconnected by a second upper cross frame member. A first hinge is rigidly connected to the first rod of the first frame member and pivotably connected to the first rod of the second frame member. The first frame member and second frame member are pivotable between a first folded position and a second unfolded position. A first stop extends from the hinge. The first stop is engageable with the first rod of the second frame member with the first frame member and second frame member in the unfolded position. A first bag support extends downwardly from the first cross frame member. The first bag support is defined by a cross bar having first and second opposite ends. The cross bar is generally parallel to the first upper cross frame member. A first u-shaped connector has first and second parallel legs. The first leg is connected to the first upper cross frame member and the second leg is connected to and coaxial with the first end of the cross bar. A second u-shaped connector has first and second parallel legs. The first leg is connected to the first upper cross frame member and the second leg is connected to and coaxial with the second end of the cross bar. A second bag support extends downwardly from the second upper cross frame member. The second bag support is defined by a cross bar having first and second opposite ends. The cross bar is generally parallel to the second upper cross frame member. A first u-shaped connector has first and second parallel legs.

The first leg is connected to the second upper cross frame member and the second leg is connected to and coaxial with the first end of the cross bar of the second bag support. A second u-shaped connector has first and second parallel legs. The first leg is connected to the second upper cross frame member and the second leg is connected to and coaxial with the second end of the cross bar of the second bag support.

A second hinge is rigidly connected to the second rod of the first frame member and pivotably connected to the second rod of the second frame member. A second stop extends from the second hinge. The second stop is engageable with the second rod of the second frame member with the first frame member and second frame member in the unfolded position.

The first frame member is further defined by a first lower cross frame member interconnecting the lower ends of first and second spaced rods of the first frame member. The second frame member is further defined by a second lower cross frame member interconnecting the lower ends of first and second spaced rods of the second frame member. Roller wheels are rotatably mounted on the first and second lower cross frame members.

In accordance with a still further aspect of the present invention, a bag frame assembly is provided for supporting a pliable bag, the bag having an upper edge defining an opening. The bag frame assembly includes first and second frames pivotably connected to each other. The first frame includes an upper cross frame member. A first bag support extends downwardly from the upper cross frame member. The first bag support and the upper cross frame member define a closed, oblong loop.

The second frame includes an upper cross frame member and the bag frame assembly further includes a second bag support extending downwardly from the upper cross frame member of the second frame. The second bag support and the upper cross frame member of the second frame define a closed, oblong loop. Alternatively, a second bag support may extend downwardly from the upper cross frame member. The second bag support and the upper cross frame member define a second closed, oblong loop. In addition, a third bag support may extend downwardly from the upper cross frame member. The third bag support and the upper cross frame member define a third closed, oblong loop.

The first frame is further defined by a lower cross frame member, generally parallel to the upper cross frame member. Roller wheels are rotatably mounted on the lower cross frame member. A hinge is rigidly connected to the first frame and pivotably connected to the second frame. The first frame and second frame are pivotable between a first folded position and a second unfolded position. A stop extends from the hinge. The stop is engageable with the second frame with the first frame and second frame in the unfolded position.

### BRIEF DESCRIPTION OF THE DRAWINGS

The drawings furnished herewith illustrate a preferred construction of the present invention in which the above advantages and features are clearly disclosed as well as other which will be readily understood from the following description of the illustrated embodiment.

In the drawings:

FIG. 1 is an isometric view of a recycling center incorporating a bag support in accordance with the present invention;

FIG. 1B is an exploded view of a portion of the recycling center of FIG. 1;

FIG. 1C is a cross-sectional view of the recycling center of the present invention taken along line 1C-1C of FIG. 1B;

FIG. 2 is an isometric view of the recycling center of the present invention with the door of the recycling center in an open position;

FIG. 3 is an isometric view of the bag support the present invention;

FIG. 4 is a side elevational view of the bag support of FIG. 3;

FIG. 5 is a cross-sectional view of the bag support of the present invention taken along line 5-5 of FIG. 3;

FIG. 6 is a cross-sectional view of the bag support of the present invention taken along line 6-6 of FIG. 3;

FIG. 7 is a cross-sectional view of the bag support of the present invention taken along line 7-7 of FIG. 4;

FIG. 8 is a cross-sectional view of the bag support of the present invention, similar to FIG. 7, with the bag support in a folded configuration;

FIG. 9 is an isometric view of a portion of an alternate embodiment of a bag support in accordance with the present invention;

FIG. 10 is an isometric view of a portion of a second alternate embodiment of a bag support in accordance with the present invention;

FIG. 11 is an isometric view of a portion of a third alternate embodiment of a bag support in accordance with the present invention;

### DETAILED DESCRIPTION OF THE DRAWINGS

A recycling center for receiving a bag support in accordance with the present invention is generally designated by the reference numeral 10. As hereinafter described, it is intended for the recycle center 10 to be supported on a supporting surface 11 and to house a bag or the like for receiving recyclable materials therein. Recycle center 10 includes first and second generally U-shaped frame members 12 and 14, respectfully. It is noted that first and second frame members 12 and 14 are identical in structure. As such, the description hereinafter of first frame member 12 is understood to describe second frame member 14 as if fully described herein.

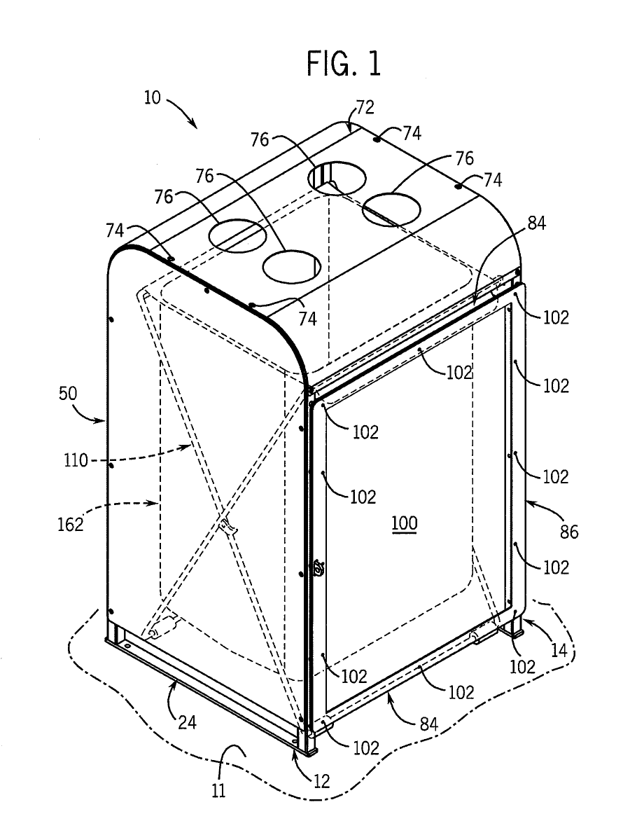

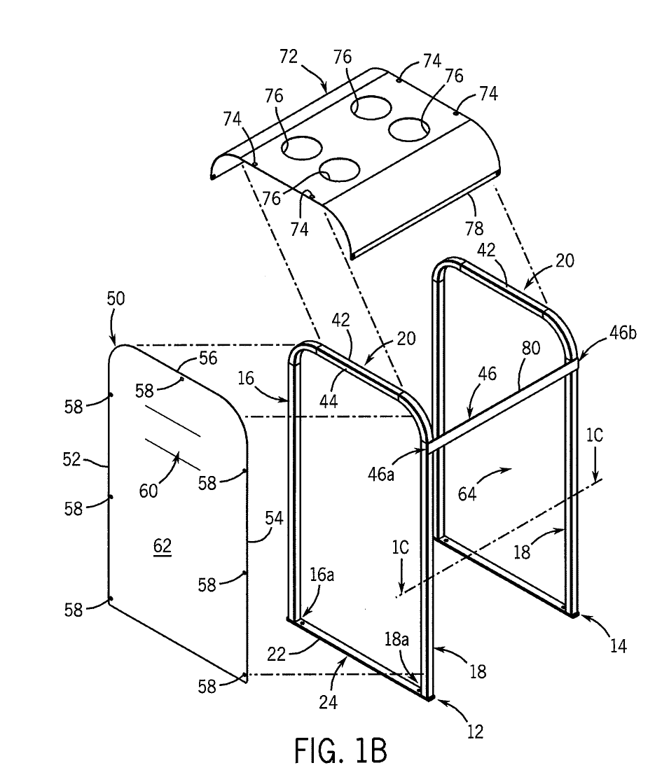

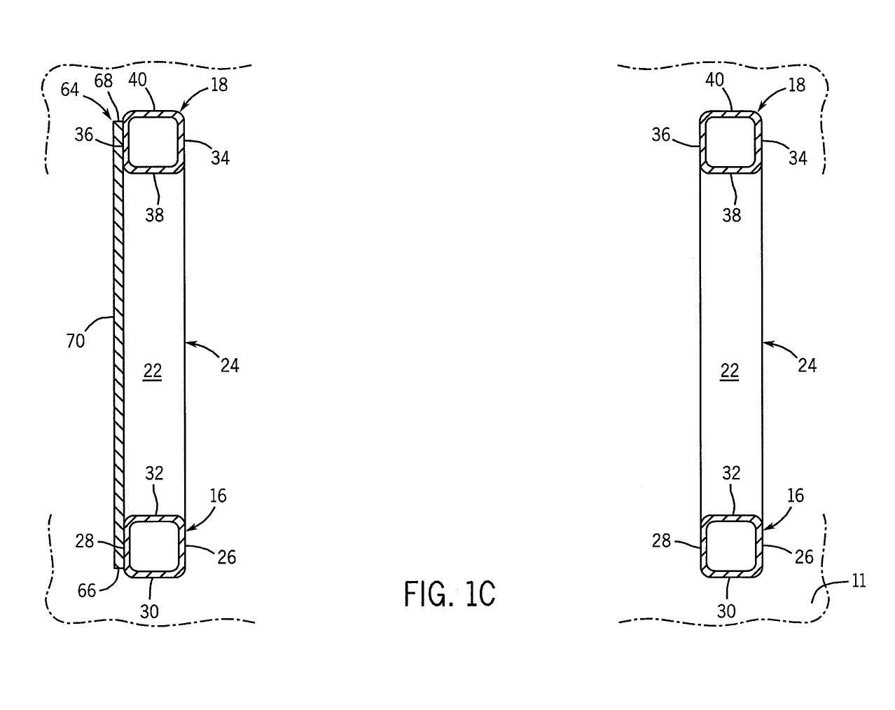

First frame member 12 is generally U-shaped and has a generally square cross section. As best seen in FIGS. 1B and 1C, first frame member 12 is defined by first and second spaced legs 16 and 18, respectfully. Upper ends of first and second legs 16 and 18, respectfully, of first frame member 12 are interconnected by upper cross leg 20. First and second legs 16 and 18 terminate at generally flat lower ends 16a and 18a, respectfully. Lower ends 16a and 18a of first and second legs 16 and 18, respectfully, of first frame member 12 are positioned on and interconnected to upper surface 22 of generally flat lower frame member 24.

First leg 16 of first frame member 12 includes a generally parallel inner and outer faces 26 and 28, respectively, interconnected by generally parallel sides 30 and 32, respectfully. Second leg 18 of first frame member 12 also includes inner and outer faces 34 and 36, respectively. Outer face 36 of second leg 18 of first frame member 12 lies in a common plane with outer face 28 of first leg 16 of first frame member 12. Inner and outer faces 34 and 36, respectively, of second leg 18 of first frame member 12 are interconnected by first and second generally parallel, spaced sides 38 and 40, respectively. Sides 30 and 40 of first and second legs 16 and 18, respectively, of first frame member 12 are interconnected by upper surface 42 of upper cross leg 20. Outer faces 28 and 36 of first and second legs 16 and 18, respectively, of first frame member 12 are interconnected by generally flat outer face 44 of cross leg 20.

First and second frame members 12 and 14, respectively, are interconnected by forward cross frame support 46. Forward cross frame support 46 includes a first end 46a affixed to side 40 of second leg 18 of first frame member 12 and a second end 46b affixed to side 40 of second leg 18 of second frame member 14. It is further contemplated to interconnect first legs 16 of first and second frame members 12 and 14, respectively, to add strength and rigidity to recycle center 10.

First panel 50 is interconnected to outer faces 28 and 36 of first and second legs 16 and 18, respectively, of first frame member 12 and to outer face 44 of upper cross leg 20 of first frame member 12. First panel 50 includes a first edge 52 aligned with side 30 of first leg 16 of first frame member 12; a second edge 54 aligned with side 40 of second leg 18 of first frame member 12; and upper edge 56 aligned with upper face 42 of upper cross leg 20 of first frame member 12. It is contemplated to interconnect first panel 50 to first frame member 20 with a plurality of spaced fasteners 58 such as rivets, screws, bolts or the like. It is further contemplated to provide indicia 16 on outer surface 62 of first panel 50 so as to allow a user to identify recycle center 10, as desired.

Second panel 64 is attached to outer faces 28 and 36 of first and second legs 16 and 18, respectively, of second frame member 14 and to outer face 44 of upper cross leg 20 of second frame member 18 by a plurality of spaced fasteners 58. Edge 66 of second panel 64 is aligned with outer face 30 of first leg 16 of second frame member 18; edge 68 of panel 64 is aligned with side 40 of second leg 18 of second frame member 14; and the upper edge of panel 64 is aligned with upper face 42 of upper cross leg 20 of second frame member 14. Outer surface 70 of second panel 64 may include indicia (not shown) to allow a user to identify recycle center 10, as desired.

Recycle center 10 may also include an optional rear panel (not shown) interconnected to first legs 16 of first and second frame members 12 and 14, respectively. In addition, recycle center 10 includes an upper panel 72 positioned on and interconnected to upper faces 42 of upper cross legs 20 of first and second frame members 12 and 14, respectively, by a plurality of fasteners 74 such as screws, bolts, and/or rivets. A plurality of apertures 76 extend through upper panel 72, for reasons hereinafter described. With upper panel 72 positioned on first and second frame members 12 and 14, respectively, forward edge 78 of upper panel 76 is adjacent upper edge 80 of forward cross support 46. As hereinafter described, upper panel 72 and first and second side panels 50 and 64, respectively, define a chamber for receiving a conventional bag 162 therein.

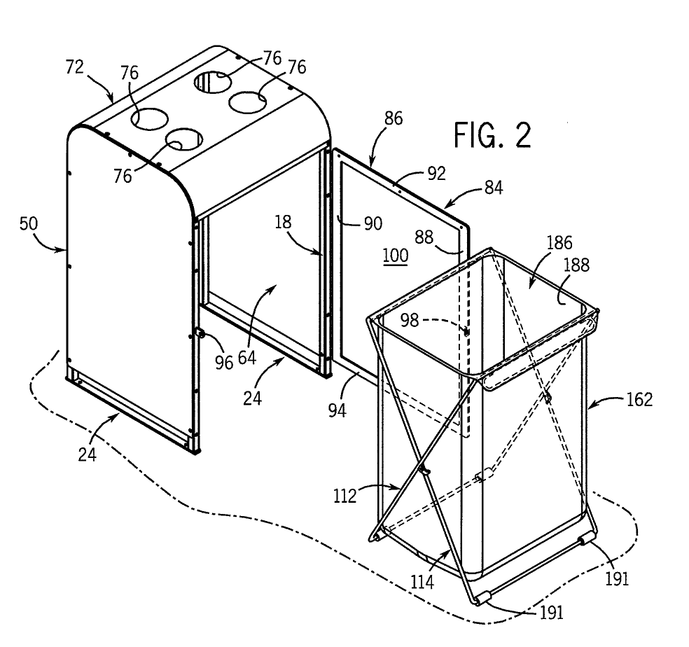

As best seen in FIGS. 1 and 2, Recycle center 10 further includes door 84 to provide access to the chamber therein. Door 84 includes a generally rectangular frame 86 having first and second side elements 88 and 90, respectively, interconnected by upper and lower frame elements 92 and 94, respectively. Side frame element 90 of frame 86 is interconnected to side 90 of second leg 18 of second frame member 14 by one or more hinges so as to allow door 84 to pivot between a closed position, FIG. 1, and an open position, FIG. 2. In order to maintain door 84 in a closed position, locking eye 96 may project from side 40 of second leg 18 of first frame element 12. Locking eye 96 is aligned with a corresponding slot 98 in side frame element 88 of frame 86 of door 84 such that with door 84 in the closed position, locking eye 96 projects through slot 98 in frame 86 of door 84. A locking bar of a conventional pad lock may be inserted through the eye of locking eye 96 to retain door 84 in its closed position. Panel 100 may be positioned within the opening defined by frame 86 and interconnected to frame 86 and retained therein by a plurality of fasteners 102. It is intended for panel 100 to be transparent in order to allow the quick and easy inspection of the chamber defined by the interior of recycle center 10.

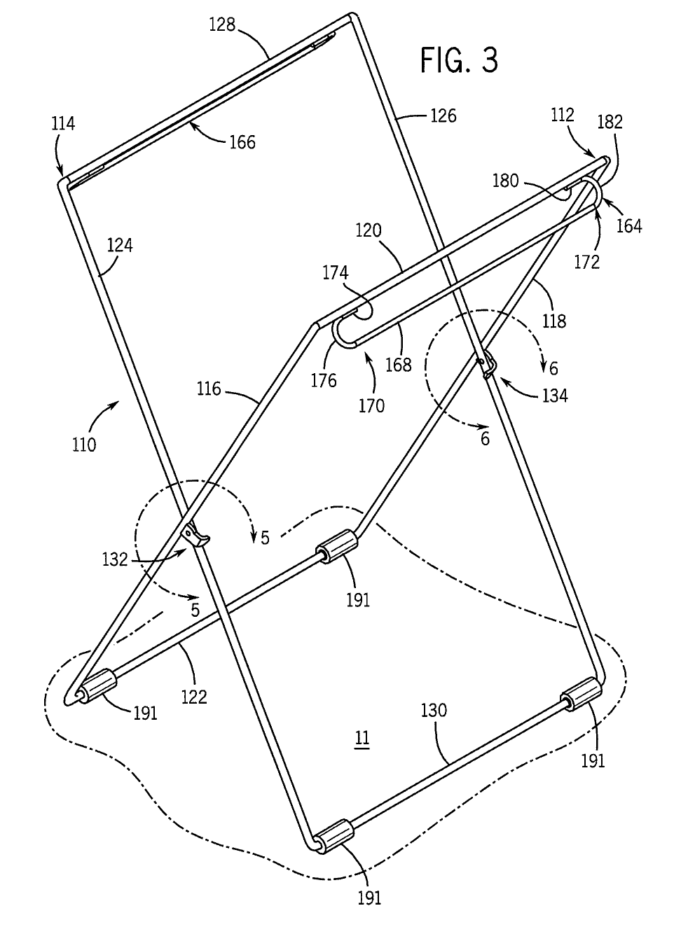

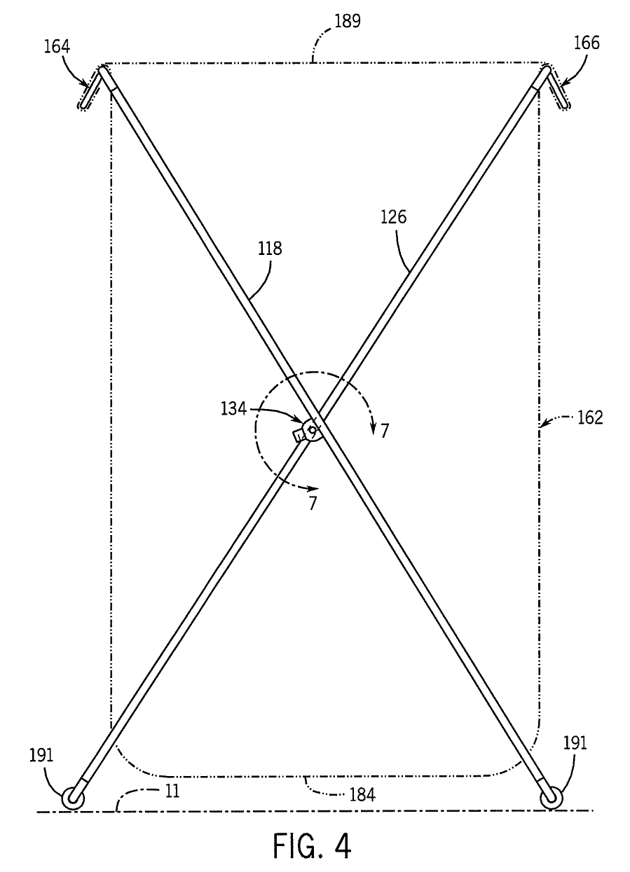

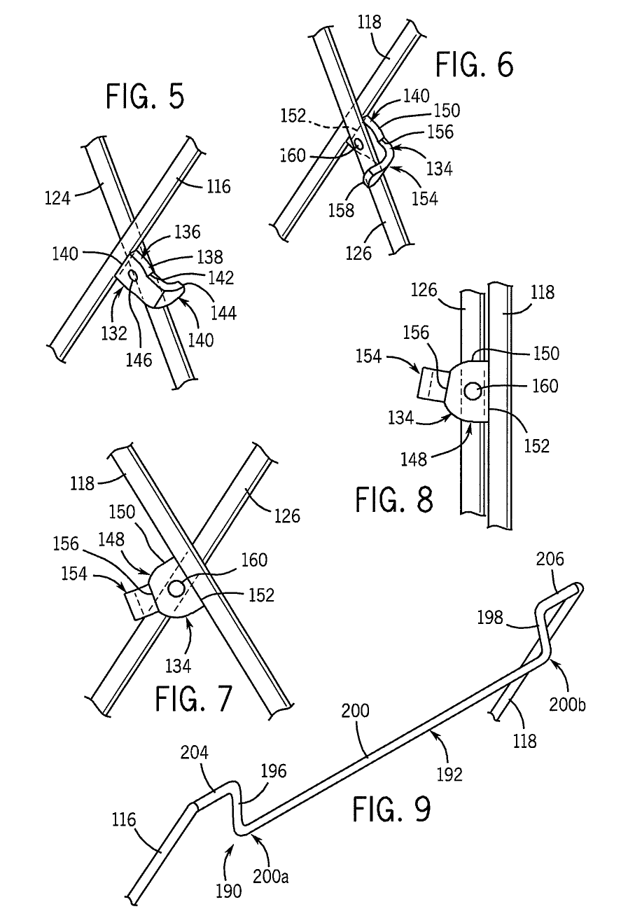

Referring to FIGS. 3-8, a bag support in accordance with the present invention is generally designated by the reference numeral 110. Bag support 110 includes first and second generally rectangular wire frames 112 and 114, respectively. As hereinafter described, second wire frame 114 is pivotably connected to first wire frame 112 and passes through the interior thereof. First wire frame 112 is defined by first and second side frame members 116 and 118, respectively, interconnected by upper and lower frame members 120 and 122, respectively. First and second side frame members 116 and 118, respectively, are generally parallel to each other. Upper and lower frame members 120 and 122, respectively, are generally parallel to each other and perpendicular to first and second side frame members 116 and 118, respectively.

Second wire frame 114 is defined by first and second side frame members 124 and 126, respectively, interconnected by upper and lower frame members 128 and 130, respectively. First and second side frame members 124 and 126, respectively, are generally parallel to each other. Upper and lower frame members 128 and 130, respectively, are generally parallel to each other and perpendicular to first and second side frame members 124 and 126, respectively.

First and second generally rectangular wire frames 112 and 114, respectively, are pivotably connected by first and second pivots 132 and 134, respectively. First pivot 132 is defined by base 136 having outer periphery 138. First side 140 of outer periphery 138 of base 136 is generally flat and bonded to first side frame member 116 such that base 136 extends from first side frame member 116 in a first direction. Stop 140 projects from second, opposite side 142 of base 136. Stop 140 includes an arm portion 144 extending along an axis generally perpendicular to the first direction toward second side frame member 118 of first wire frame 112. Pivot pin 146 extend through base 136 of first pivot 132 and into first side frame member 124 of second wire frame 114 so as to pivotably connect first side frame member 124 of second wire frame 114 to first pivot 132, and hence, to first side frame member 116 of first wire frame 112.

Second pivot 134 is defined by base 148 having outer periphery 150. First side 152 of outer periphery 150 of base 148 is generally flat and bonded to second side frame member 118 such that base 148 extends from second side frame member 118 in the first direction. Stop 154 projects from second, opposite side 156 of base 148. Stop 154 includes an arm portion 158 extending along an axis generally perpendicular to the first direction toward first side frame member 116 of first wire frame 112. It is intended for the arm portions 144 and 158 of first and second pivots 132 and 134, respectively, to lie on a common axis. Pivot pin 160 extends through base 148 of second pivot 134 and into second side frame member 126 of second wire frame 114 so as to pivotably connect second side frame member 126 of second wire frame 114 to second pivot 134, and hence, to second side frame member 118 of first wire frame 112. It is intended for pivot pins 146 and 160 to lie on a common pivot axis.

As described, first and second frames 112 and 114, respectively, are pivotable between an unfolded configuration, FIG. 3, for supporting a bag during filling and a folded configuration, FIG. 8, wherein the first and second frames 112 and 114, respectively, lie in generally parallel planes for storage and transport of the bag support 110. With bag support 110 in its unfolded configuration, first and second side frame members 124 and 126, respectively, of second frame 114 engage corresponding stops 140 and 154 extending from first and second side frame members 116 and 118, respectively, of first frame 112 such that stops 140 and 154 retain first and second frames 112 and 114, respectively, in their unfolded configuration, FIG. 3, and prevent second frame 114 from continuing to pivot with respect to first frame 112 on pivot pins 146 and 160.

Bag 162 is retained on bag support 110 by first and second bag mounts 164 and 166, respectively, operatively connected to upper frame members 120 and 128 of first and second frames 112 and 114, respectively. It is noted that first and second bag mounts 164 and 166, respectively, are identical in structure. As such, the description hereinafter of first bag mount 164 is understood to describe second bag mount 166, as if fully described herein.

First bag mount 164 includes bar 168 extending along a longitudinal axis and having first and second opposite ends 170 and 172, respectively. Bar 168 is generally parallel to and positioned below and laterally spaced from upper frame member 120 of first frame 112. First bag mount 164 includes a first mounting portion 174 that is generally parallel to bar 168 and is interconnected to upper frame member 120 of first frame 112. First mounting portion 174 is interconnected to bar 168 by a generally arcuate, concave portion 176. First bag mount 164 further includes a second mounting portion 180 generally parallel to central bar 168 and interconnected to upper frame member 120 of first frame 112. Second mounting portion 180 of first bag mount 164 is interconnected to bar 168 by a generally arcuate, concave portion 182. Bar 164, concave portions 176 and 182 and first and second mounting portions 174 and 180, respectively, of first bag mount 164 lie in a common plane and at an acute angle to supporting surface 11 with first and second frames 112 and 114, respectively, in their unfolded configuration, FIG. 3.

In operation, bag 162, preferably transparent, is provided. As is conventional, bag 162 includes a closed bottom end 184 and an opposite open end 186. Open end 186 of bag 162 includes opening 188 defined by upper peripheral edge 189. A first portion of the upper edge 189 of bag 162 is pulled over upper frame member 120 of first frame 112 and is wrapped around first bag mount 164 such that concave portions 176 and 182 of first bag mount 164 retains bag 162 thereon. A second portion of the upper edge 189 of bag 162 is pulled over upper frame member 120 of second frame 114 and is wrapped around second bag mount 166 such that concave portions 176 and 182 of second bag mount 166 retain bag 162 thereon. With bag 162 mounted on bag support 110, as heretofore described, opening 188 in bag 162 is directed upwardly between upper frame members 120 of first and second frames 114 and 116, respectively. Thereafter, bag support 110 is inserted into the chamber defined by recycle center 10 such that opening 188 in bag 162 is axially aligned with openings 76 through upper panel 72 of recycle center 10. As such, any items to be recycled that are deposited in opening 76 in upper panel 72 of recycle center 10 will be received within bag 162 through opening 188 therein. It can be appreciated that a plurality of rollers 191 may be rotatably mounted to lower frame members 122 and 130 of first and second frames 112 and 114, respectively, to facilitate the movement of bag support 110 into and out of the chamber defined by recycle center 10.

Referring to FIG. 9, it is contemplated to replace upper frame members 120 and 128 of first and second frames 112 and 114, respectively, as well as, first and second bag mounts 164 and 166, respectively, by an alternate bag mount, generally designated by the reference numeral 190. Bag mount 190 is defined by a generally U-shaped member 192 having first and second legs 196 and 198, respectively, interconnected by an elongated rod 200. Ends 200a and 200b of rod 200 are spaced from corresponding first and second side frame members 116 and 118, respectively, of first frame 112 or corresponding first and second side frame members 124 and 126, respectively, of second frame 114. The terminal end of first leg 196 of each bag mount 190 is interconnected to a corresponding first side frame member 116 and 124 of first and second frames 112 and 114, respectively, by connection rod 204. The terminal end of second leg 198 of each bag mount 190 is interconnected to a corresponding second side frame member 118 and 126 of first and second frames 112 and 114, respectively, by connection rod 206. U-shaped members 192, connection rods 204 and connection rods 206 lie in a common plane and at an acute angle to supporting surface 11 with first and second frames 112 and 114, respectively, in their unfolded configuration, FIG. 3.

In operation, a first portion of the upper edge 189 of bag 162 is pulled over connection rods 204 and 206 of first frame 112 and is wrapped around bag mount 190 such that legs 196 and 198 of U-shaped member 192 retain bag 162 thereon. A second portion of the upper edge 189 of bag 162 is pulled over connection rods 204 and 206 of second frame 114 and is wrapped around bag mount 190 such that legs 196 and 198 of U-shaped member 192 retain bag 162 thereon. With bag 162 mounted on bag support 110, as heretofore described, opening 188 in bag 162 is directed upwardly between upper bag mounts 190 of first and second frames 114 and 116, respectively. Thereafter, bag support 110 is inserted into the chamber defined by recycle center 10 such that opening 188 in bag 162 is axially aligned with openings 76 through upper panel 72 of recycle center 10.

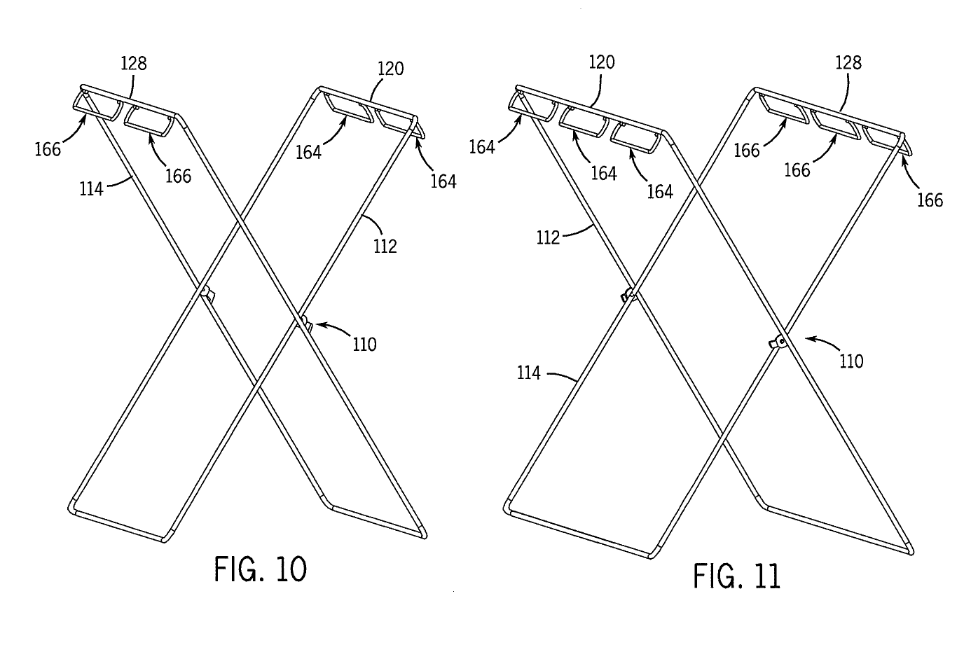

Referring to FIGS. 10-11, it is contemplated to provide a plurality of first bag mounts 164 on upper frame member 120 of first frame 112 and an equal number of second bag mounts 166 on upper frame member 128 of second frame 114. By way of example, a pair of axially spaced first bag mounts 164 may be mounted upper frame member 120 of first frame 112 and an equal number of second bag mounts 166 on upper frame member 128 of second frame 114, FIG. 10. As a result, a pair of bags 162 may be supported on bag support 110 as heretofore described. Similarly, referring to FIG. 11, three axially spaced first bag mounts 164 may be provided upper frame member 120 of first frame 112 and an equal number of second bag mounts 166 may be provided on upper frame member 128 of second frame 114. As a result, three bags 162 may be supported on bag support 110 as heretofore described. It can be appreciated that additional bag mounts may be provided on upper frame members 120 and 128 of first and second frames 112 and 114, respectively, without deviating from the scope of the present invention.

Various modes of carrying out the invention are contemplated as being within the scope of the following claims particularly pointing out and distinctly claiming the subject matter which is regarded as the invention.

1. A bag frame assembly for supporting a pliable bag, the bag having an upper edge defining an opening, comprising:
a first frame member defined by first and second spaced rods having upper and lower ends, the upper ends of the rods interconnected by a first upper cross frame member;
a second frame member pivotably connected to the first frame member and being defined by first and second spaced rods having upper and lower ends, the upper ends of the rods interconnected by a second upper cross frame member;
a first bag support extending downwardly from the first cross frame member, the first bag support and the first cross frame member defining a closed, oblong loop; and
a second bag support extending downwardly from the second cross frame member, the second bag support and the second cross frame member defining a closed, oblong loop.

2. The bag frame assembly of claim 1 wherein the first bag support is defined by:
a cross bar having first and second opposite ends, the cross bar being generally parallel to the first cross frame member;
a first u-shaped connector having first and second parallel legs, the first leg being connected to the first upper cross frame member and the second leg being connected to and coaxial with the first end of the cross bar; and
a second u-shaped connector having first and second parallel legs, the first leg being connected to the first upper cross frame member and the second leg being connected to and coaxial with the second end of the cross bar.

3. The bag frame assembly of claim 2 wherein the second bag support is defined by:
a cross bar having first and second opposite ends, the cross bar being generally parallel to the second upper cross frame member;
a first u-shaped connector having first and second parallel legs, the first leg being connected to the second upper cross frame member and the second leg being connected to and coaxial with the first end of the cross bar of the second bag support; and
a second u-shaped connector having first and second parallel legs, the first leg being connected to the second upper cross frame member and the second leg being connected to and coaxial with the second end of the cross bar of the second bag support.

4. The bag frame assembly of claim 1 further comprising a first hinge rigidly connected to the first rod of the first frame member and pivotably connected to the first rod of the second frame member, the first frame member and second frame member pivotable between a first folded position and a second unfolded position.

5. The bag frame assembly of claim 4 further comprising a second hinge rigidly connected to the second rod of the first frame member and pivotably connected to the second rod of the second frame member.

6. The bag frame assembly of claim 4 further comprising a stop extending from the first hinge, the stop engageable with the first rod of the second frame member with the first frame member and second frame member in the unfolded position.

7. The bag frame assembly of claim 1 wherein the first frame member is further defined by a first lower cross frame member interconnecting the lower ends of first and second spaced rods of the first frame member and wherein the second frame member is further defined by a second lower cross frame member interconnecting the lower ends of first and second spaced rods of the second frame member.

8. The bag frame assembly of claim 7 first comprising roller wheels rotatably connected to the first and second lower cross frame members.

9. A bag frame assembly for supporting a pliable bag, the bag having an upper edge defining an opening, comprising:
a first frame member defined by first and second spaced rods having upper and lower ends, the upper ends of the rods interconnected by a first upper cross frame member;
a second frame member defined by first and second spaced rods having upper and lower ends, the upper ends of the rods interconnected by a second upper cross frame member;
a first hinge rigidly connected to the first rod of the first frame member and pivotably connected to the first rod of the second frame member, the first frame member and second frame member pivotable between a first folded position and a second unfolded position;
a first stop extending from the hinge, the first stop engageable with the first rod of the second frame member with the first frame member and second frame member in the unfolded position;
a first bag support extending downwardly from the first cross frame member, the first bag support being defined by:
a cross bar having first and second opposite ends, the cross bar being generally parallel to the first upper cross frame member;
a first unshaped connector having first and second parallel legs, the first leg being connected to the first upper cross frame member and the second leg being connected to and coaxial with the first end of the cross bar; and
a second u-shaped connector having first and second parallel legs, the first leg being connected to the first upper cross frame member and the second leg being connected to and coaxial with the second end of the cross bar; and
a second bag support extending downwardly from the second upper cross frame member, the second bag support being defined by:
a cross bar having first and second opposite ends, the cross bar being generally parallel to the second upper cross frame member;
a first u-shaped connector having first and second parallel legs, the first leg being connected to the second upper cross frame member and the second leg being connected to and coaxial with the first end of the cross bar of the second bag support; and
a second u-shaped connector having first and second parallel legs, the first leg being connected to the second upper cross frame member and the second leg being connected to and coaxial with the second end of the cross bar of the second bag support.

10. The bag frame assembly of claim 9 further comprising a second hinge rigidly connected to the second rod of the first frame member and pivotably connected to the second rod of the second frame member.

11. The bag frame assembly of claim 10 further comprising a second stop extending from the second hinge, the stop engageable with the second rod of the second frame member with the first frame member and second frame member in the unfolded position.

12. The bag frame assembly of claim 9 wherein the first frame member is further defined by a first lower cross frame member interconnecting the lower ends of first and second spaced rods of the first frame member and wherein the second frame member is further defined by a second lower cross frame member interconnecting the lower ends of first and second spaced rods of the second frame member.

13. The bag frame assembly of claim 12 first comprising roller wheels rotatably mounted on the first and second lower cross frame members.

14. A bag frame assembly for supporting a pliable bag, the bag having an upper edge defining an opening, comprising:
first and second frames pivotably connected to other, the first frame including an upper cross frame member;
a first bag support extending downwardly from the upper cross frame member, the first bag support and the upper cross frame member defining a closed, oblong loop.

15. The bag frame assembly of claim 14 wherein the second frame includes an upper cross frame member and wherein the bag frame assembly further comprises a second bag support extending downwardly from the upper cross frame member of the second frame, the second bag support and the upper cross frame member of the second frame defining a closed, oblong loop.

16. The bag frame assembly of claim 14 further comprising a second bag support extending downwardly from the upper cross frame member, the second bag support and the upper cross frame member defining a second closed, oblong loop.

17. The bag frame assembly of claim 16 further comprising a third bag support extending downwardly from the upper cross frame member, the third bag support and the upper cross frame member defining a third closed, oblong loop.

18. The bag frame assembly of claim 14 wherein the first frame is further defined by a lower cross frame member, generally parallel to the upper cross frame member.

19. The bag frame assembly of claim 18 first comprising roller wheels rotatably mounted on the lower cross frame member.

20. The bag assembly of claim 14 further comprising a hinge rigidly connected to the first frame and pivotably connected to the second frame, the first frame and second frame pivotable between a first folded position and a second unfolded position; and
a stop extending from the hinge, the stop engageable with the second frame with the first frame and second frame in the unfolded position.
